(19) United States
(12) Patent Application Publication
(10) Pub. No.: US 2012/0252448 A1
(43) Pub. Date: Oct. 4, 2012

(54) METHODS AND APPARATUSES FOR TRIGGERING THE REPORTING OF NEIGHBOR RELATION INFORMATION

(75) Inventors: Brian Martin, Surrey (GB); Keiichi Kubota, Surrey (GB)

(73) Assignee: RENESAS MOBILE CORPORATION, Tokyo (JP)

(21) Appl. No.: 13/279,889

(22) Filed: Oct. 24, 2011

Related U.S. Application Data
(63) Continuation of application No. 13/078,266, filed on Apr. 1, 2011.

(30) Foreign Application Priority Data
Apr. 1, 2011 (GB) GB1105648.8

(51) Int. Cl. H04W 60/00; H04W 4/00

(52) U.S. Cl. 455/435.1; 455/422.1

(57) ABSTRACT

Various methods for triggering the reporting of neighbor relation information are provided. One example method may include causing neighbor cell relation information to be stored in association with a transition from a first radio access technology to a second radio access technology, and determining that a user equipment has idle mode signaling reduction enabled. The example method may also include in response to at least performing the transition and determining that the user equipment has idle mode signaling reduction enabled, causing a connection to be established to send a neighbor cell relation information indicator, which indicates that the neighbor cell relation information is available to be reported from a user equipment to a network entity. Similar and related example methods, example apparatuses, and example computer program products are also provided.

### CROSSREFERENCE TO RELATED APPLICATIONS

This application is a continuation of U.S. application Ser. No. 13/078,266, filed Apr. 1, 2011, which is hereby incorporated herein in its entirety by reference. This application also claims the benefit of United Kingdom application number GB1105648.8, filed Apr. 1, 2011.

### TECHNICAL FIELD

Various embodiments relate generally to wireless communications, and, more particularly, relate to a method, apparatus, and computer program product for triggering the reporting of neighbor relation information.

### BACKGROUND

Communications technology continues to evolve, particularly in the area of wireless communications. While some evolutionary changes are relatively small, others can introduce entirely new platforms that involve the installation of different network infrastructure and new software. Since the construction of network infrastructure can be very costly, companies are not always able to quickly upgrade their entire network from older platforms to newer platforms. As such, there is often a period where devices must be configured to operate on both new and legacy platforms. Not only do challenges arise from the need to develop devices that can operate on both platforms, but increasingly complex challenges can arise due to the need for graceful transitions of communications sessions between the different types of platforms without negatively impacting user experience.

### SUMMARY

Example methods and apparatuses are described herein that provide for triggering the reporting of neighbor relation information reporting. One example method may include causing neighbor cell relation information to be stored in association with a transition from a first radio access technology to a second radio access technology, and determining that a user equipment has idle mode signaling reduction enabled. The example method may also include, in response to at least performing the transition and determining that the user equipment has idle mode signaling reduction enabled, causing a connection to be established to send a neighbor cell relation information indicator, which indicates that the neighbor cell relation information is available to be reported from a user equipment to a network entity.

Another example embodiment is an example apparatus that comprises specifically configured processing circuitry. In this regard, the processing circuitry may be configured to cause neighbor cell relation information to be stored in association with a transition from a first radio access technology to a second radio access technology, and determine that a user equipment has idle mode signaling reduction enabled. The processing circuitry may be further configured to, in response to at least performing the transition and determining that the user equipment has idle mode signaling reduction enabled, cause a connection to be established to send a neighbor cell relation information indicator, which indicates that the neighbor cell relation information is available to be reported from a user equipment to a network entity.

Yet another example embodiment is an apparatus or article of manufacture in the form of a nontransitory computer readable medium having program code stored thereon. The program code, when executed by an apparatus, may configure processing circuitry to perform various functionalities. In this regard, the program code may configure the processing circuitry to cause neighbor cell relation information to be stored in association with a transition from a first radio access technology to a second radio access technology, and determine that a user equipment has idle mode signaling reduction enabled. The program code may further configure the processing circuitry to, in response to at least performing the transition and determining that the user equipment has idle mode signaling reduction enabled, cause a connection to be established to send a neighbor cell relation information indicator, which indicates that the neighbor cell relation information is available to be reported from a user equipment to a network entity.

Another example apparatus may include means for causing neighbor cell relation information to be stored in association with a transition from a first radio access technology to a second radio access technology. The example apparatus may further include means for determining that a user equipment has idle mode signaling reduction enabled, and means for causing a connection to be established to send a neighbor cell relation information indicator, which indicates that the neighbor cell relation information is available to be reported from a user equipment to a network entity, in response to at least performing the transition.

### BRIEF DESCRIPTION OF THE DRAWINGS

Having thus described some example embodiments in general terms, reference will now be made to the accompanying drawings, which are not necessarily drawn to scale, and wherein:

FIG. 1 illustrates an example system and connections involved in a transfer between cells having different radio access technologies according to some example embodiments;

FIG. 2 illustrates a signaling diagram describing operations that may be performed to trigger the reporting of neighbor relation information according to some example embodiments;

FIG. 3 illustrates a block diagram of a wireless communications apparatus and associated system configured to trigger the reporting of neighbor relation information according to some example embodiments; and

FIG. 4 illustrates an example flowchart for triggering the reporting of neighbor relation information according to some example embodiments.

### DETAILED DESCRIPTION

Example embodiments will now be described more fully hereinafter with reference to the accompanying drawings, in which some, but not all embodiments are shown. Indeed, embodiments may take many different forms and should not be construed as limited to those set forth herein. Like reference numerals refer to like elements throughout. As used herein, the term ‘circuitry’ refers to components that include at least one electronic hardware device that is either statically configured via a manufacturing or initialization process to perform particular functionality, dynamically configurable through the execution of program code instructions to perform particular functionality, or a combination thereof.

Example methods and example apparatuses are provided herein that facilitate the triggering of neighbor cell relation information reporting. According to various example embodiments, the reporting of neighbor cell relation information from a user equipment (UE) (e.g., a wireless communications device) to a network entity may be performed to obtain or update neighbor relation information held at the network level. The neighbor cell relation information may include attributes about a cell that have been gathered or measured by the UE. For example, neighbor cell relation information may include attributes such as, but not limited to, frequency used for communications with the cell, a physical cell identifier (PCI), a global cell identifier (GCI), or the like. The neighbor cell relation information may be reported in response to a transition of a UE from a cell that is operating in accordance with a first radio access technology to a cell that is operating in accordance with a second radio access technology.

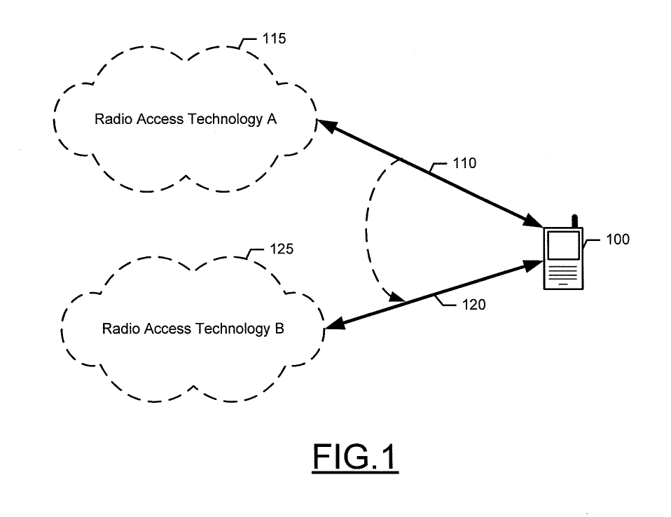

FIG. 1 illustrates an example of such a transition between cells that are configured to use different radio access technologies. In this regard, UE 100 is transitioning from a connection 110 to cell 115 that uses radio access technology A to a connection 120 to cell 125 that uses radio access technology B. The transition may occur because the UE 100 may be physically moving out of the geographic area that is covered by cell 115 and into a geographic area that is covered by cell 125. When the UE 100 transfers from one cell to another, the process that is performed may be referred to a cell selection or cell reselection. According to various example embodiments, the transition may be referred to as an interradio access technology (interRAT) transfer. An interRAT transfer may involve a transfer from an evolved universal mobile telecommunications system (UMTS) terrestrial radio access (UTRA) network (EUTRAN) to a UTRA network (UTRAN). Further, the interRAT transition may be from an long term evolution (LTE) network or a global system for mobile communications (GSM) enhanced data rates for GSM evolution (EDGE) radio access network (GERAN) network to a UTRAN.

Prior to or during this transition, the UE 100 may receive or measure attributes of the prior cell (e.g., cell 115), and store those attributes as neighbor cell relation information. According to some example embodiments, the attributes may be stored as automatic neighbor relation (ANR) information. Some example embodiments determine when the UE 100 may provide an indication that this neighbor cell relation information is available to the network, and when the UE 100 may report the neighbor cell relation information to the new target cell (e.g. cell 125).

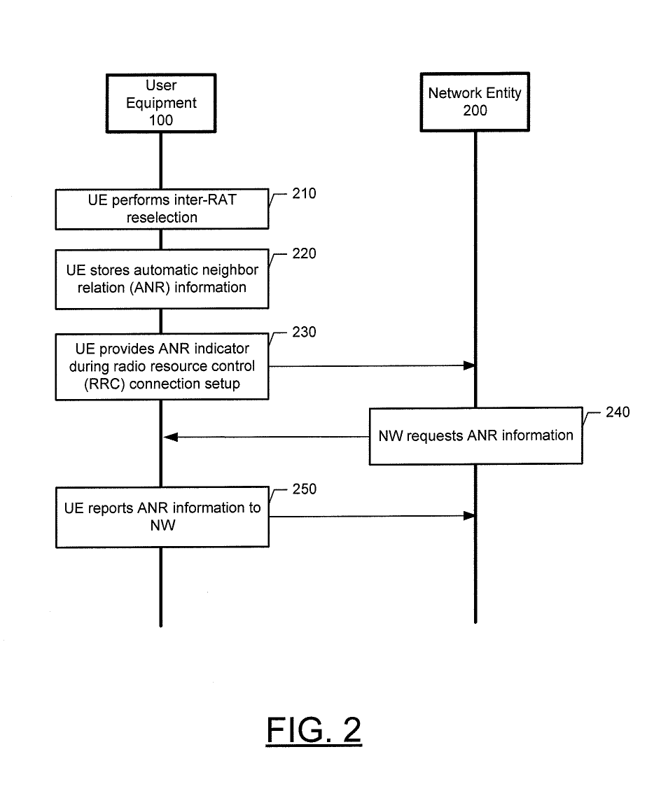

FIG. 2 illustrates a signaling diagram that describes the interactions between the UE 100 and a network entity 200 of a target cell to report ANR information during or in association with an inter-RAT transfer. The network entity 200 may be any type of network entity, such as, but not limited to a base station, a radio network controller (RNC), or the like. Although the following examples are directed to inter-RAT ANR, example embodiments are also contemplated that operate with respect to intra-UMTS ANR.

At 210, the UE 100 may perform an inter-RAT reselection and transfer to a cell having a different RAT (e.g., a UTRAN cell). According to some example embodiments, the UE may perform the reselection from a GERAN or from and LTE network to a UTRAN. The network entity 200 may, according to some example embodiments, be an RNC of a UTRAN.

At 220, the UE 100 may store ANR information from the cell that the UE 100 is transitioning away from. The ANR information may include the frequency used for communications with the cell, a physical cell identifier (PCI), a global cell identifier (GCI), or the like. The UE 100 may store the ANR information after having previously measured or otherwise obtained the ANR information from the previous cell. According to some example embodiments, the UE 100 may store the ANR information in a data log. Further, according to some example embodiments, the UE may store or log the ANR information when the UE is camping on the target cell.

Subsequently, at 230, the UE 100 may provide an ANR indicator to the network entity 200. The indicator may be provided during a radio resource control (RRC) connection setup routine. The RRC connection setup routine may be part of a registration procedure with the target cell. The ANR indicator may notify the network entity 200 that the UE 100 is in possession of valid ANR information from a previous cell. In this regard, prior to sending the ANR indicator, the UE 100 may verify that the ANR information is valid by means of, for example, verifying that the cell for which the ANR information should be provided to is of the same public land mobile network (PLMN) as the cell for which the ANR configuration was received, by verifying that the previous cell information is not already broadcast on the neighbour list of the new cell, or by verifying that the ANR log or configuration is still valid according to a fixed validity timer. According to various example embodiments, the ANR indicator may be a one bit segment of the RRC setup completion process message that indicates that the UE 100 has stored ANR information.

Upon being notified that the UE 100 has ANR information, the network entity 200, at 240, may send a request to the UE 100 requesting that the UE 100 report the ANR information to the network entity. In some example embodiments, the network entity 200 may analyze the system information that is accessible to the network entity to determine whether a request for the ANR information from the UE 100 is needed. The request to the UE 100 may be provided within a UE INFORMATION REQUEST message. Upon receiving the request for the ANR information, the UE 100 may be configured to send or report the ANR information to the network entity 200 at 250. The ANR information may be provided in the form of a UE INFORMATION RESPONSE message. Upon providing the ANR information to the network entity 200 (e.g., when the ANR session ends), the UE 100 may clear, delete, or mark the ANR information to permit the information to be overwritten in the memory of the UE 100. In some example embodiments, the UE 100 may be configured to clear, delete, or mark the ANR information after receiving an acknowledgement that the network entity 200 has received the ANR information reporting.

In the procedure described in FIG. 2, it is presumed that the network desires, and therefore requests, the ANR information from the UE 100. However, in some instances, the network may not require the ANR information and therefore may not request the information from the UE 100, in response to receiving the ANR indicator. According to some example embodiments, if the network does not request the ANR information within a threshold period of time the UE 100 may clear, delete, or mark the ANR information to be overwritten. The UE 100 may then be configured to continue ANR logging. According to some example embodiments, when an intraUTMS reselection is performed, the UE need not discard the ANR information if the ANR information is not immediately requested. Further, the network entity may determine not to request the ANR information in a number of different scenarios. For example, the network entity may not require the ANR information because the ANR information to be provided by the UE may already be populated in the system information at the network entity. Alternatively, for example, the network entity may not support ANR.

Again referencing FIG. 2, the UE 100 at 230 may need to be configured to provide the ANR indicator. This indicator may be provided in response to the initiation of an RRC connection setup procedure. However, in some instances, the RRC connection setup procedure may not be initiated, and therefore the indicator may not be provided. In this regard, if the UE is currently configured to perform idle mode signaling reduction (ISR), then the UE 100 may be registered with previous RAT cell and the new RAT cell simultaneously. ISR is a technique that permits a UE to remain simultaneous registered in an UTRAN/GERAN Routing Area (RA) and an EUTRAN Tracking Area (TA) list. Accordingly, the UE may be able to make cell reselections between EUTRAN and UTRAN/GERAN without a need to send a request while the UE remains within the registered RA and TA lists. As such, the UE may not perform registration upon an inter-RAT change when ISR is , and the UE 100 may not attempt to access the new target RAT cell. The ANR information may therefore be left unused because no ANR indicator has been provided.

According to various example embodiments, to force the UE 100 to provide the neighbor cell relation information indicator (e.g., ANR information indicator), the UE 100 may be configured to disable ISR internally. Disabling the ISR may, according to some example embodiments, require a non access stratum (NAS) change. In this regard, according to various example embodiments, the UE 100 may be configured to, upon having stored valid neighbor cell relation information, disable the ISR in an instance in which the UE 100 is performing an inter-RAT reselection, for example, to a UTMS cell. According to various example embodiments, the UE 100 may disable the ISR internally. Since the ISR is disabled, the UE 100 may be forced to perform the registration process with the target cell and perform the RRC connection setup upon selecting, for example, the UTRAN cell. The neighbor cell relation information indicator may therefore be provided as part of the RRC connection setup indicating the availability of the neighbor cell relation information log data. As such, according to some example embodiments, the UE may be configured to deactivate or disable ISR locally by, for example, setting the UE's temporary identity used in next update (TIN) to a temporary identity of the currently used RAT cell when the UE performs reselection from EUTRAN to UTRAN and a valid ANR configuration is stored.

In addition to, or in the alternative to disabling ISR, the UE may be configured to trigger an RRC connection setup or establishment in response to inter-RAT reselection. According to some example embodiments, the RRC connection setup may be triggered in response to the neighbor cell relation information (e.g., the ANR information) also being valid. As such, since the RRC connection setup may be automatically triggered, the neighbor cell relation indicator may be provided as part of the RRC connection setup, and the neighbor cell relation information may be requested by, and provided to, the network in response to receiving the indicator.

In order to implement this triggering of the RRC connection setup, the UE may be configured to trigger RRC connection establishment in response to the neighbor cell relation information being enabled and valid, and/or, according to some example embodiments, in response to ISR being . According to some example embodiments, a new RRC connection establishment cause may be utilized or a new indicator may be used to indicate that the neighbor cell relation information is available for reporting.

In view the forgoing, the implementation of various example embodiments may prevent situations where the UE does not access a target UMTS cell during an ANR inter-RAT reporting scheme, thereby removing ambiguity from the procedure and forcing the UE to provide the neighbor cell relation indicator to the network. The techniques described above, according to various example embodiments, may operate to simplify the inter-RAT ANR procedure for the UE and the network. In this regard, according to some example embodiments, the UE may always report the ANR information from an inter-RAT cell to the target UTRAN cell, and therefore there may be no need to store the ANR information for later use. As such, according to various example embodiments, additional memory within the UE may be made available for performing intra-UMTS ANR. Further, various example embodiments avoid missing reports of ANR information relating to an inter-RAT transfer.

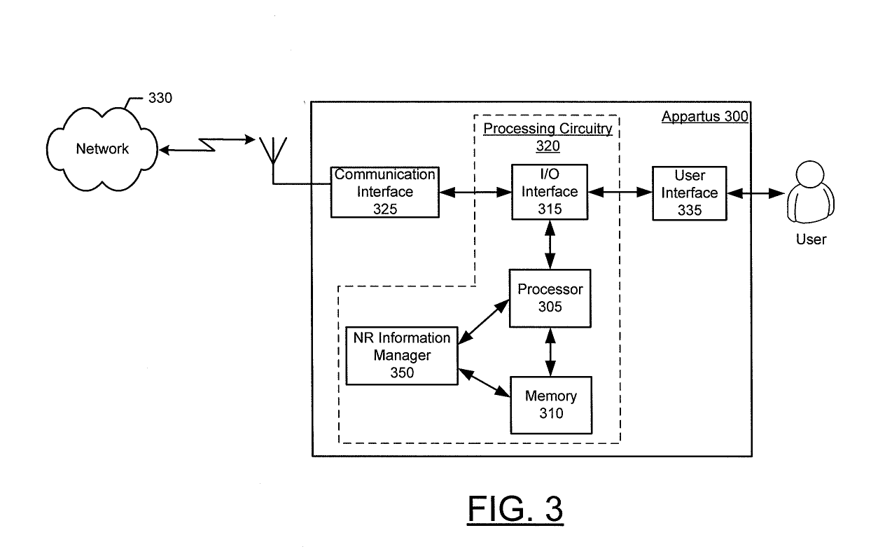

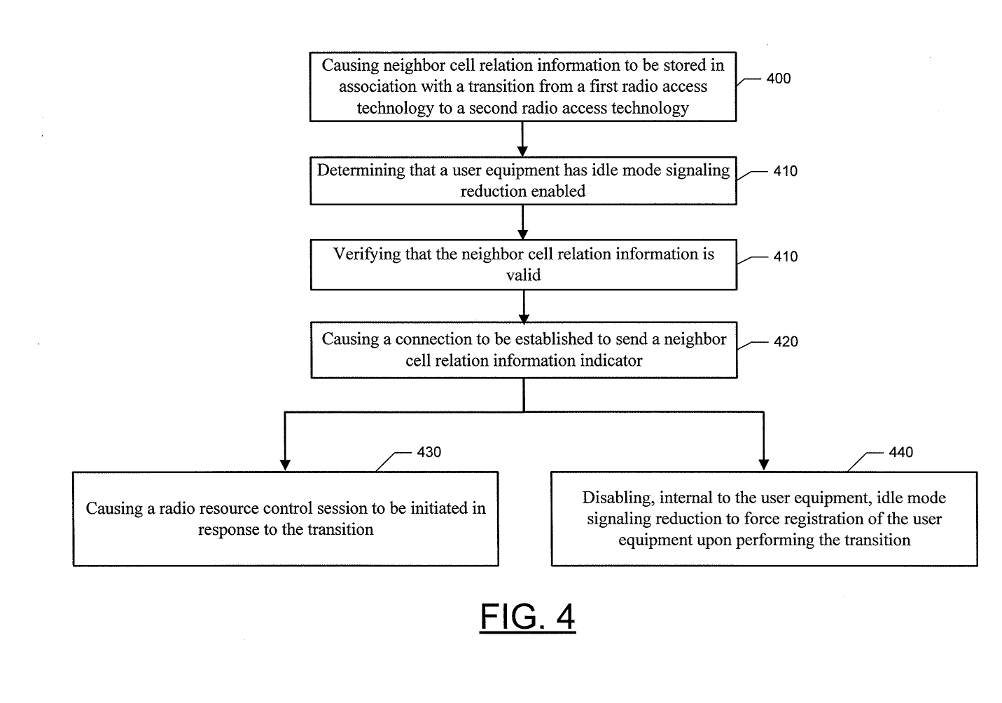

Having described at least some of the example embodiments in a system and method context, FIG. 3 depicts an example apparatus that may be configured to perform various functionalities as described herein, including those described with respect to operations described above and with respect to the flowcharts of FIGS. 2 and 4. FIG. 3 illustrates an apparatus configured to operate in accordance with the functionality of UE 100 described above. FIG. 4 provides an example flowchart of some of the functionality performed by the UE 100.

Referring now to FIG. 3, an example embodiment is depicted as apparatus 300, which may be embodied as a wireless communications device or a portion thereof. As a wireless device, the apparatus 300 may be a mobile or stationary. In this regard, the apparatus 300 may embody or be a component of a server, computer, access point, handheld device (e.g., telephone, smartphone, tablet, digital book reader, portable digital assistant (PDA), gaming device, video/audio recorder, video/audio player, a global positioning system (GPS) device), any combination of the aforementioned, or the like.

The example apparatus 300 may include a processor 305, a memory 310, an Input/Output (I/O) interface 315, a communications interface 325, a user interface 335, and an neighbor relation (NR) information manager 350. The processor 305 and the NR information manager 350 may be collectively referred to as processing circuitry 320. In some example embodiments, the memory 310 and/or the I/O interface 315 may also be included in the processing circuitry 320, as depicted in FIG. 3.

The processor 305 may, according to some example embodiments, be embodied as various means for implementing the functionalities described herein, including those described with respect to the apparatus 300. The processor 305 may be embodied in a number of forms. For example, the processor 305 may be a microprocessor, a coprocessor, a controller, a specialpurpose integrated circuit such as, for example, an ASIC (application specific integrated circuit), an FPGA (field programmable gate array), multiples and combinations thereof, or the like. In another example, the processor 305 may include one or more core processing devices that operate in concert. As such, the processor 305 may be a hardware device that may be comprised of a plurality of transistors, logic gates, a clock (e.g., oscillator), other circuitry, and the like to facilitate performance of the functionalities described herein. In some example embodiments, the processor 305 may be specifically configured through the execution of instructions or program code stored in a memory device such as memory 310 to perform specific functionality as described herein. In some example embodiments, the processor 305 may be completely or partially hardcoded to perform specific functionality as described herein. As such, through its specific structural configuration, the processor 305 may perform, and embody a means for performing, the various example methods, algorithms, and operations described herein.

The memory 310 may any type of hardware device that operates to store data and provide the stored data upon request. The data stored within the memory 310 may be instructions or program code that may be executed by the processor 305 to specially configure the processor 305. As such, in conjunction with the processor 305, the memory 310 may be a structural part of a means for performing various functionalities described herein. The memory 310 may be a tangible and/or nontransitory computerreadable storage medium. Memory 310 may be a volatile memory device (e.g., volatile random access memory, cache, or the like) and/or a nonvolatile memory device (e.g., solid state memory, magnetic or optical storage devices, or the like). In some example embodiments, the memory 310 may be in communication with the processor 305 and/or other components via a shared bus.

The I/O interface 315 may be any device or circuitry configured to interface the processor 305 with other circuitry or devices, such as the communications interface 325 and the user interface 335. In some example embodiments, the I/O interface may embody or be in communication with a bus that is shared by multiple components within the processing circuitry 320 or the apparatus 300. In some example embodiments, the processor 305 may interface with the memory 310 via the I/O interface 315. The I/O interface 315 may be configured to convert signals (e.g., digital or analog signals) and data into a form that may be interpreted by the processor 305. The I/O interface 315 may also perform buffering of inputs and outputs to support the operation of the processor 305. According to some example embodiments, the processor 305 and the I/O interface 315 may be combined onto a single package, chip, or integrated circuit configured to perform, or cause the apparatus 300 to perform, various functionalities.

In some embodiments, the components that make up the processing circuitry 320 may embody or be a part of a chip or a chip set. In other words, the processing circuitry 320 may comprise one or more physical packages (e.g., chips, boards, or the like). In some example embodiments, other components and functionality may be included in the same physical package. For example, in some example embodiments, the circuitry supporting the communications interface and/or the circuitry supporting the user interface may be disposed together with the processing circuitry on a single chip to generate a “system on a chip” embodiment. As such, in some cases, a chip or chipset may constitute means for performing the functionalities described herein.

The communication interface 325 may be any component device configured to facilitate the receiving and/or transmitting of data from/to a network 330, which may be any type of wireless network including, but not limited to, a cellular network, a Wifi network, or the like. The communications interface may be configured to communicate information via any type of wired or wireless connection, and via any type of communications protocol that the communications interface 325 may be configured to support. Further, the communications interface 325 may be configured to support devicetodevice communications for implementation when, for example, the apparatus 300 is a member of a mobile ad hoc network. Processor 305 may also be configured to facilitate communications via the communications interface 325 by, for example, controlling hardware included within the communications interface 325 (e.g., the antenna). In this regard, the communication interface 325 may include, for example, communications driver circuitry (e.g., circuitry that supports wired or wireless communications), one or more antennas, a transmitter, a receiver, a transceiver and/or supporting hardware, including, for example, a processor for enabling communications. Via the communication interface 325, the example apparatus 300 may communicate with various other network entities in a devicetodevice fashion and/or via indirect communications through a base station, access point, server, gateway, router, or the like.

The user interface 335 may include any hardware configured to provide output to, or receive input from, a user. In this regard, the user interface 335 may include, for example, a keyboard, a mouse, a joystick, microphone (e.g., for using voice commands), a display (e.g., a touch screen display), a speaker, camera, accelerometer, vibrating motor (e.g., to provide haptic feedback), or other input/output mechanisms. Further, the processor 305 may comprise, or be in communication with, user interface circuitry configured to control the user interface components. In some example embodiments, the user interface 335 may have a dedicated processor and the processing circuitry 320 may interface with the dedicated user interface processor to control the user interface components. In some example embodiments, the processor 305 may use the I/O interface 315 to output signals that control the user interface 335.

The NR information manager 350 of example apparatus 300 may be embodied in the configuration of the processor 305, either through the static configuration of the processor 305 (e.g., as an ASIC, FPGA, or the like) or through the execution of instructions stored in the memory 310. As such, via the NR information manager 350, the processor 305 and the processing circuitry 320 may be configured to carry out the functions described herein, to thereby direct the operation of the apparatus 300. According to some example embodiments, the NR information manager 350 may be wholly embodied in the processor 350, or some of the functionality of NR information manager 350 may be embodied in other components of the apparatus 300 or a larger system. Further, the NR information manager 350 may configure the processing circuitry 320 and the apparatus 300 to perform the functionalities described above with respect to the operation of UE 100.

Via the NR information manager 350, the processing circuitry 320 may be configured to perform the operations provided in, for example, the flowchart of FIG. 4 to facilitate the operation of the apparatus 300. In this regard, at 300, the processing circuitry 320 may be configured to cause neighbor cell relation information to be stored in association with a transition from a first radio access technology to a second radio access technology at 400. The processing circuitry 320 may be further configured, at 410, to determine that the user equipment has idle mode signaling reduction (ISR) enabled. At 420, the processing circuitry may be configured to cause a connection (e.g., an RRC connection) to be established to send a neighbor cell relation information indicator, in response to at least performing the transition and determining that the user equipment has idle mode signaling reduction enabled. The neighbor cell relation information indicator may indicate that the neighbor cell relation information is available to be reported from a user equipment to a network entity. At 430, the processing circuitry 320 may be configured to verify that the neighbor cell relation information is valid. In this regard, the processing circuitry 320 may be configured to cause the neighbor cell relation information indicator to be sent in response to at least performing the transition and verifying that the neighbor cell relation information is valid.

In accordance with various example embodiments, the processing circuitry 320 may be further configured to, at 450, disable, internal to the user equipment, idle mode signaling reduction to force registration of the user equipment upon performing the transition. Additionally, or alternatively, at 440, the processing circuitry 320 may be configured to cause a radio resource control session (e.g., an RRC connection setup session) to be initiated in response to the transition and determining that the user equipment has idle mode signal reduction enabled to, again, force registration of the user equipment upon performing the transition.

Additionally, or alternatively, the processing circuitry 320 may be further configured to receive a request for the neighbor cell relation information from the network entity and cause the neighbor cell relation information to be sent to the network entity. According to some example embodiments, the processing circuitry 320 may additionally or alternatively be configured to cause the neighbor cell relation information to be stored in association with the transition from the first radio access technology to the second radio access technology, the second radio access technology being a universal mobile telecommunications system terrestrial radio access (UTRA) technology.

FIGS. 2 and 4 illustrate flowcharts describing the operations of example systems, methods, and/or computer program products (e.g., program code stored on a nontransitory computer readable medium) according to example embodiments. It will be understood that each operation of the flowcharts, and/or combinations of operations in the flowcharts, can be implemented by various means as described above and otherwise herein. Means for implementing the operations of the flowcharts, combinations of the operations in the flowchart, or other functionality of example embodiments described herein may include the processing circuitry 320 in its various forms as described above. In this regard, for example, program code instructions for performing the operations and functions of apparatus 300 and/or operations and functions otherwise described herein may be stored on a memory, such as memory 310 and may be executed by a processor, such as the processor 305. As will be appreciated, any such program code instructions may be loaded onto a computer or other programmable apparatus (e.g., processor 305, or the like) from a computerreadable medium to produce a particular machine, such that the particular machine becomes a means for implementing the functions specified in the flowcharts' operations. These program code instructions may direct a processor or other programmable apparatus to function in a particular manner to thereby generate a particular machine or particular article of manufacture. Further, the instructions stored in the memory may produce an article of manufacture, where the article of manufacture becomes a means for implementing the functions specified in the flowcharts' operations. Retrieval, loading, and execution of the program code instructions may be performed sequentially such that one instruction is retrieved, loaded, and executed at a time. However, in some example embodiments, retrieval, loading and/or execution may be performed, partially or wholly, in parallel such that multiple instructions are retrieved, loaded, and/or executed together. Additionally, it is understood that one or more operations of the flowcharts, and combinations of operations in the flowcharts, may be implemented by special purpose hardwarebased computer systems and/or processors which perform the specified functions, or combinations thereof via special purpose hardware.

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific ones disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. A method for controlling a user equipment, the method comprising:
causing neighbour cell relation information to be stored in association with a transition from a first radio access technology to a second radio access technology;
determining that the user equipment has idle mode signalling reduction enabled; and
in response to at least performing the transition and determining that the user equipment has idle mode signalling reduction enabled, causing a connection to be established to send a neighbour cell relation information indicator, which indicates that the neighbour cell relation information is available to be reported from the user equipment to a network entity.

2. The method of claim 1, further comprising verifying that the neighbour cell relation information is valid,
wherein the neighbour cell relation information indicator is sent in response to at least performing the transition and verifying that the neighbour cell relation information is valid.

3. The method of claim 1, wherein causing the neighbour cell relation information indicator to be sent includes disabling, internal to the user equipment, the idle mode signalling reduction to force registration of the user equipment upon performing the transition.

4. The method of claim 1, wherein causing the connection to be established includes causing a radio resource control session to be initiated in response to the transition and determining that the user equipment has the idle mode signal reduction enabled.

5. The method of claim 1, further comprising receiving a request for the neighbour cell relation information from the network entity and causing the neighbour cell relation information to be sent to the network entity.

6. The method of claim 1, wherein causing neighbour cell relation information to be stored includes causing the neighbour cell relation information to be stored in association with the transition from the first radio access technology to the second radio access technology, the second radio access technology being a universal mobile telecommunications system terrestrial radio access (UTRA) technology.

7. An apparatus for use in controlling a user equipment, the apparatus comprising a processing system configured at least to:
cause neighbour cell relation information to be stored in association with a transition from a first radio access technology to a second radio access technology;
determine that the user equipment has idle mode signalling reduction enabled; and
in response to at least performing the transition and determining that the user equipment has idle mode signalling reduction enabled, cause a connection to be established to send a neighbour cell relation information indicator, which indicates that the neighbour cell relation information is available to be reported from a user equipment to a network entity.

8. The apparatus of claim 7, wherein the processing system is further configured to verify that the neighbour cell relation information is valid; and wherein the processing system configured to cause the neighbour cell relation information indicator to be sent is further configured to cause the neighbour cell relation information indicator to be sent in response to at least performing the transition and verifying that the neighbour cell relation information is valid.

9. The apparatus of claim 7, wherein the processing system configured to cause the neighbour cell relation information indicator to be sent includes being configured to disable, internal to the user equipment, the idle mode signalling reduction to force registration of the user equipment upon performing the transition.

10. The apparatus of claim 7, wherein the processing system configured to cause the connection to be established includes being configured to cause a radio resource control session to be initiated in response to the transition and determining that the user equipment has the idle mode signal reduction enabled.

11. The apparatus of claim 7, wherein the processing system is further configured to receive a request for the neighbour cell relation information from the network entity and cause the neighbour cell relation information to be sent to the network entity.

12. The apparatus of claim 7, wherein the processing system configured to cause neighbour cell relation information to be stored includes being configured to cause the neighbour cell relation information to be stored in association with the transition from the first radio access technology to the second radio access technology, the second radio access technology being a universal mobile telecommunications system terrestrial radio access (UTRA) technology.

13. The apparatus of claim 7, wherein the apparatus comprises a communications interface configured to wirelessly send the neighbour cell relation information indicator.

14. A nontransitory computer readable medium having program code stored thereon, the program code, when executed, configures a processing system of a user equipment at least to:
cause neighbour cell relation information to be stored in association with a transition from a first radio access technology to a second radio access technology;
determine that the user equipment is implementing idle mode signalling reduction; and
in response to at least performing the transition and determining that the user equipment has idle mode signalling reduction enabled, cause a connection to be established to send a neighbour cell relation information indicator, which indicates that the neighbour cell relation information is available to be reported from the user equipment to a network entity.

15. The computer readable medium of claim 14, wherein the program code further configures the processing system to verify that the neighbour cell relation information is valid; and wherein program code that configures the processing system to cause the neighbour cell relation information indicator to be sent further configures the processing system to cause the neighbour cell relation information indicator to be sent in response to at least performing the transition and verifying that the neighbour cell relation information is valid.

16. The computer readable medium of claim 14, wherein the program code that configures the processing system to cause the neighbour cell relation information indicator to be sent further configures the processing system to disable, internal to the user equipment, the idle mode signalling reduction to force registration of the user equipment upon performing the transition.

17. The computer readable medium of claim 14, wherein the program code that configures the processing system to cause the connection to be established further configures the processing system to cause a radio resource control session to be initiated in response to the transition and determining that the user equipment has the idle mode signal reduction enabled.

18. The computer readable medium of claim 14, wherein the program code further configures the processing system to receive a request for the neighbour cell relation information from the network entity and cause the neighbour cell relation information to be sent to the network entity.

19. The computer readable medium of claim 14, wherein the program code that configures the processing system to cause neighbour cell relation information to be stored further configures the processing system to cause the neighbour cell relation information to be stored in association with the transition from the first radio access technology to the second radio access technology, the second radio access technology being a universal mobile telecommunications system terrestrial radio access (UTRA) technology.
